(19) United States
(12) Patent Application Publication
(10) Pub. No.: US 2012/0034895 A1
(43) Pub. Date: Feb. 9, 2012

(54) Circuit and Method for Peak Detection with Hysteresis

(75) Inventors: Li Xuechu, Beijing (CN); Peiqi Xuan, Saratoga, CA (US)

(73) Assignee: QUINTIC HOLDINGS, Santa Clara, CA (US)

(21) Appl. No.: 12/908,880

(22) Filed: Oct. 21, 2010

Related U.S. Application Data
(60) Provisional application No. 61/370,103, filed on Aug. 3, 2010.

(51) Int. Cl. H04B 1/16

(52) U.S. Cl. 455/341

(57) ABSTRACT

In a communication system, the signal received or transmitted is required to be maintained within a range for proper operation. For example, a radio frequency signal received from an antenna is usually amplified by a low-noise amplifier (LNA) with adjustable gain. The input RF signal is properly amplified by the LNA further processing by subsequently receive path of the receiver. A peak detector may be used to detect the peak amplitude of the amplified input and provides a proper gain for the LNA. The detected peak amplitude may be affected by the noises which may inadvertently cause the gain control to fluctuate randomly. In order to avoid the above issues, some hysteresis has to be built into the peak detection so that the gain control will not be so sensitive to the noise. The present invention discloses a system and method for peak detection with accurate hysteresis. The peak detection uses a high threshold path and a low threshold path to derive the high and low thresholds for gain control with hysteresis. The high threshold path and the low threshold path use pre-amplifiers with different gain factors to amplify low level signals to overcome the non-linearity issue of input-output transfer characteristic of the peak detectors and consequently results in a peak detection system with accurate hysteresis.

### CROSS REFERENCE TO RELATED APPLICATIONS

The present invention claims priority to U.S. Provisional Patent Application, No. 61/370,103, filed Aug. 3, 2010, entitled “Circuit and Method for Peak Detection with Hysteresis.” The U.S. Provisional Patent Application is hereby incorporated by reference in its entirety.

### FIELD OF THE INVENTION

The present invention relates to communication systems. In particular, the present invention relates to peak detection with hysteresis using a high threshold path and a low threshold path to derive accurate hysteresis.

### BACKGROUND

In a communication system, the signal received or transmitted is required to be maintained within a range for proper operation. For example, a radio frequency signal received from an antenna is usually amplified by a low-noise amplifier (LNA) with adjustable gain. The input RF signal is properly amplified using the LNA for further processing through the subsequent receive path of the receiver. In order to select a proper LNA gain to amplify the input signal, the amplitude of the amplified input is monitored. For example, a peak detector may be used to detect the peak of the amplified input. If the amplified signal amplitude is too high, the LNA gain is lowered. If the amplified signal amplitude is too low, the LNA gain is raise. Consequently, the amplified signal will be always within a desired range.

In many receiver systems, the frequency of the RF signal is usually high. Therefore the peak detector required for the gain control has to operate at high frequencies. At the same time, the RF signal is usually small and susceptible to noises. The detected peak amplitude may be affected by noises which may inadvertently cause the gain control to fluctuate randomly and frequently so as to cause the system to perform improperly. In order to avoid the above issues, some hysteresis mechanism has to be built into the peak detection so that the gain control will not be so sensitive to the noise. Existing peak detector circuits often exhibit a nonlinear characteristic of input-output transfer function, particularly for small input signal. Therefore, the detected peak amplitude for small input signal may be inaccurate. A peak detection circuit having a hysteresis characteristic has been disclosed in the U.S. Pat. No. 5,334,930, entitled “Peak Detection Circuit”. However, the U.S. Pat. No. 5,334,930 does not address the issue of input-output transfer characteristic of the peak detector and consequently will suffer noticeable hysteresis error. Therefore, it is much desired to develop a peak detector operable at high frequencies and providing accurate hysteresis.

### BRIEF SUMMARY OF THE INVENTION

A system and method for peak detection with hysteresis is disclosed. The peak detection system comprises a high threshold path and a low threshold path, wherein both paths are coupled to an input signal to detect the instances of peak signal exceeding the high threshold and the instances of peak signal falling below the low threshold respectively. The high threshold path and the low threshold path each comprise a pre-amplifier and a peak detection circuit, where the gains of the pre-amplifiers can be adjusted and the reference voltages for the respective peak detection circuits can be adjusted. Since most peak detection circuits exhibit non-linear transfer characteristic, particularly at low signal level, amplifying the input signal will bring the signal level to a more linear region for accurate peak detection. In one embodiment of the peak detection with accurate hysteresis, the peak detectors for the high threshold path and the low threshold path have the same size and the same reference voltage is applied to both peak detectors.

The method for peak detection with accurate hysteresis comprises: providing a first gain factor for amplifying the input signal to obtain a first amplified signal; providing a second gain factor for amplifying the input signal to obtain a second amplified signal, wherein the second gain factor is larger than the first gain factor; providing a first reference signal to a first peak detection circuit to obtain a high threshold output, wherein the first reference signal is associated with high threshold reference signal modified by the first gain factor; and providing a second reference signal to a second peak detection circuit to obtain a low threshold output, wherein the second reference signal is associated with low threshold reference signal modified by the second gain factor. Since most peak detection circuits exhibit non-linear transfer characteristic, particularly at low signal level, amplifying the input signal will bring the signal level to a more linear region for accurate peak detection. In yet another embodiment of the peak detection with accurate hysteresis, the method further includes a step of matching the first reference signal with the second reference signal by selecting the first gain factor and the second gain factor according to (the first gain factor*the high threshold reference signal)=(the second gain factor*the low threshold reference signal).

### BRIEF DESCRIPTION OF THE DRAWINGS

FIG. 1 illustrates an RF receiver system with an AGC loop where the AGC loop comprises a peak detector.

FIG. 2A illustrates peak-to-peak values of an input signal.

FIG. 2B illustrates peak values of an input signal.

FIG. 3 illustrates traditional peak detection with hysteresis using a high threshold path and a low threshold path.

FIG. 4 is the transfer characteristic of the high frequency peak detector disclosed by Meyer.

FIG. 5A illustrates the structure of peak detection with accurate hysteresis where pre-amplifiers are used in the high threshold path and the low threshold path to improve hysteresis error.

FIG. 5B illustrates the structure of peak detection with accurate hysteresis where the same reference voltage is supplied to both peak detectors in the high threshold path and the low threshold path.

FIG. 6 illustrates the schematic of an exemplary high gain pre-amplifier for the systems of FIGS. 5A and 5B.

FIG. 7 illustrates the schematic of an exemplary low gain pre-amplifier for the systems of FIGS. 5A and 5B.

FIG. 8 illustrates the schematic of an exemplary high frequency peak detector for the systems of FIGS. 5A and 5B.

FIG. 9 shows simulated hysteresis error corresponding to the peak detection of FIG. 5B using the high gain pre-amplifier of FIG. 6, the low gain pre-amplifier of FIG. 7, and the peak detector of FIG. 8.

### DETAILED DESCRIPTION OF THE INVENTION

FIG. 1 illustrates a communication receiver 100 using an automatic gain control (AGC) to automatically adjust the gain of the front-end LNA in order to allow the receiver to be used with a wide dynamic input range. The AGC loop comprises peak detection 112 to detect the peak amplitude of the signal amplified by the LNA 104. The peak detection provides digital information related to the detected amplitude and one or more reference signal. The digital information, such as multiple bits to indicate whether the amplitude of input signal is above or below reference signals, is provided to a digital signal processing (DSP) module 114 so that the DSP may generate proper control signal for the LNA according to the digital information. The detected peak amplitude is used to control the LNA gain. In this particular example, the DSP module 114 is used to derive the necessary control signal for the LNA. The DSP module 114 is also used in the main receive path to perform other receiver tasks, where the RF signal arrives at the antenna 102 and amplified by the variable-gain LNA 104. The amplified signal is then mixed with a local oscillation signal at the mixer 106 and filtered by a filter 108. The filtered signal is then converted into a digital signal using an analog to digital converter (ADC) 110. The DSP module 114 can offer abundant processing in the digital domain such as noise shaping, demodulation, sampling rate conversion and etc. In this example shown in FIG. 1, the DSP module 114 is also used to derive the control signal for the variable-gain LNA according to the digital information provided by the peak detection 112. The exemplary receive is used to illustrate an implementation using peak detection in the AGC loop. The structure of the receiver system shall not be construed as limitations to the present invention. The present invention is directed to peak detection system and method and can be used in any receive system that has a need for LNA gain adjustment. Furthermore, the current invention can also be used in other parts of a communication system. For example, in an AGC circuit to maintain the proper level of an intermediate frequency (IF) signal, there is also a need to detect the peak of the IF signal.

While a receiver system is illustrated as an exemplary system that may incorporate the peak detection with accurate hysteresis, other communication systems may also be benefited by incorporating an embodiment of the present invention. For example, a transmitter system is often required to monitor the transmitted power to ensure the transmitted power is at a desired level. In order to measure the transmitted power, a portion of transmitted signal may be coupled from the transmit antenna using a coupler. Peak detection may be used as a means to determine the transmitted power. Therefore, the nonlinear transfer characteristic of the peak detector used in the peak detection may also cause hysteresis error in the transmitter system. Consequently, an embodiment of the invention will also improve hysteresis error in the transmitter system as well.

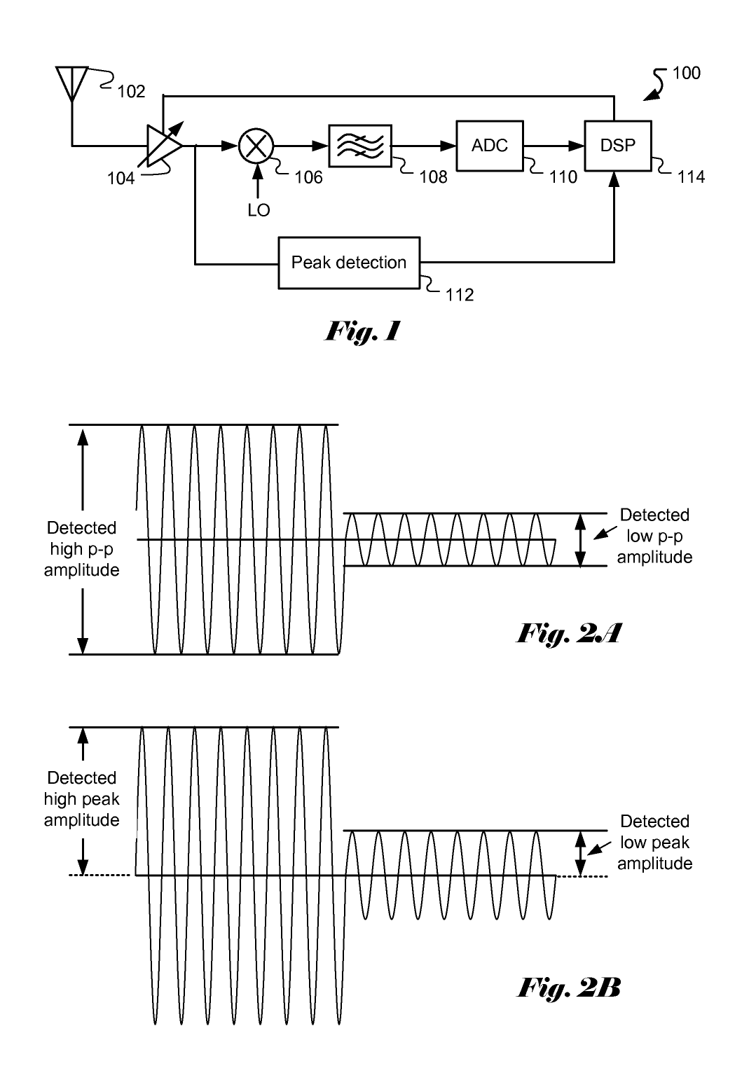

A peak detector can be designed to detect peak-to-peak value of the signal envelop as shown in FIG. 2A or to detect the peak value of the signal from the DC value as shown in FIG. 2B. The peak detector should have a long enough time constant so that it will be insensitive to the rapid change of the underline high frequency signal, such as the RF signal and consequently, the peak detector will be able to hold the peak value of the signal. On the other hand, the peak detector should be able to adapt to the signal fast enough so as to follow the contour of the peak envelop. The present invention can be used with the type of peak detection in FIG. 2A as well as the type of peak detection in FIG. 2B.

System architecture of peak detection 300 offering the hysteresis characteristic is shown in FIG. 3. The system comprises parallel paths 310 and 320 to detect the high peak amplitude and low peak amplitude for differential input signal pair Vip and Vin. The path 310 comprises a high-threshold peak detector PKDH 314 and a comparator 316 to provide a digital output signal CH. The path 320 comprises a low-threshold peak detector PKDL 324 and a comparator 326 to provide a digital output signal CL. The high threshold path 310 will generate a high output, i.e., CH=‘1’ if the amplitude of input signal is higher than the high reference voltage VREF_H. When the detected peak amplitude is higher than VREF_H, the block PKDH 314 will produce a positive signal to cause the comparator 316 to output a logic high signal “1”. Otherwise, the block PKDH 314 will output a negative signal to cause the comparator 316 to output a logic low signal, “0”. The low threshold will generate a high output, i.e., CL=‘1’ if the amplitude of input signal is smaller than the low reference voltage VREF_L. When the detected peak amplitude is lower than VREF_L, the block PKDH 324 will produce a positive signal to cause the comparator 326 to output a logic high signal “1”. Otherwise, the block PKDL 324 will output a negative signal to cause the comparator 326 to output a logic low signal “0”. The high reference voltage VREF_H and the low reference voltage VREF_L can be properly selected to control the input signal so that the input signal will be maintained between the high reference voltage VREF_H and the low reference voltage VREF_L. The dual thresholds VREF_H and VREF_L utilized by the peak detection module of FIG. 3 provides hysteresis so that the noise in the input signal will not cause frequent gain adjustment inadvertently. If the error introduced by the peak detectors 314 and 324 is ignored, the hysteresis is defined by 20·log(VREF_H/VREF_L).

FIG. 3 illustrates exemplary peak detection with hysteresis using the high threshold path 310 and the low threshold path 320 to derive digital control information associated with input signal and one or more reference signal. While the high threshold path and the low threshold path are each implemented using a peak detector with a reference signal and a comparator as shown in FIG. 3, it is known to these skilled in the art that the high threshold path and the low threshold path may be implemented by others circuit arrangement. The present invention is not limited to the particular implementation of the high threshold path 310 and the low threshold path 320. While a peak detector PKDH followed by a comparator is used as an example to illustrate one implementation of peak detection, peak detection of an input signal with respect to a reference signal may also be implemented according to other circuit arrangement. The present implementation is not limited to the particular implementation of peak detection circuit.

The peak detector used by the block 314 and 324 has to support high frequency operation. In order to accommodate the need for high frequency operation, the peak detector used by the block 314 and 324 has to be carefully designed. There are various peak detector circuits known to these skilled in the art. For example, the bipolar peak detector disclosed by Meyer in a publication entitled “Low-Power Monolithic RF Peak Detector Analysis”, IEEE Journal of Solid-State Circuit, Vol. 30, pp. 65-67, January 1995, can be used as an exemplary implementation of peak detector. The operation frequency of the bipolar peak detector reported by Meyer can be as high as several GHz. Therefore, Meyer's peak detector has been widely used in the AAC (automatic amplitude control) loop of VCO (voltage controlled oscillator) and other high frequency system, such as LNA due to its high frequency performance. Nevertheless, the present invention can be implemented based on other peak detector circuits as well.

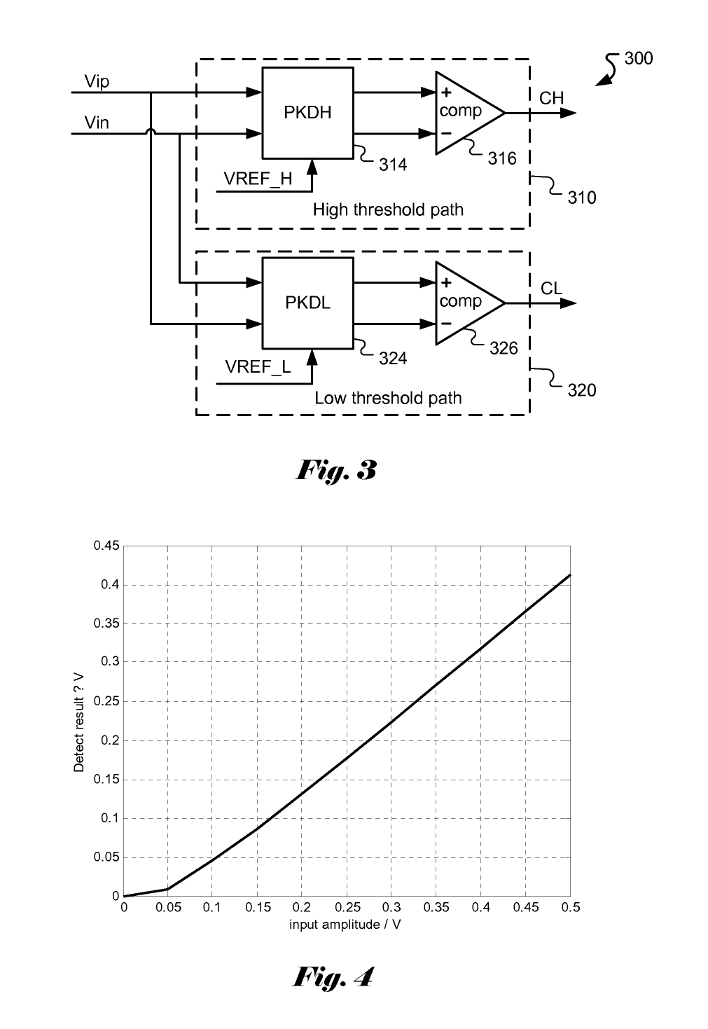

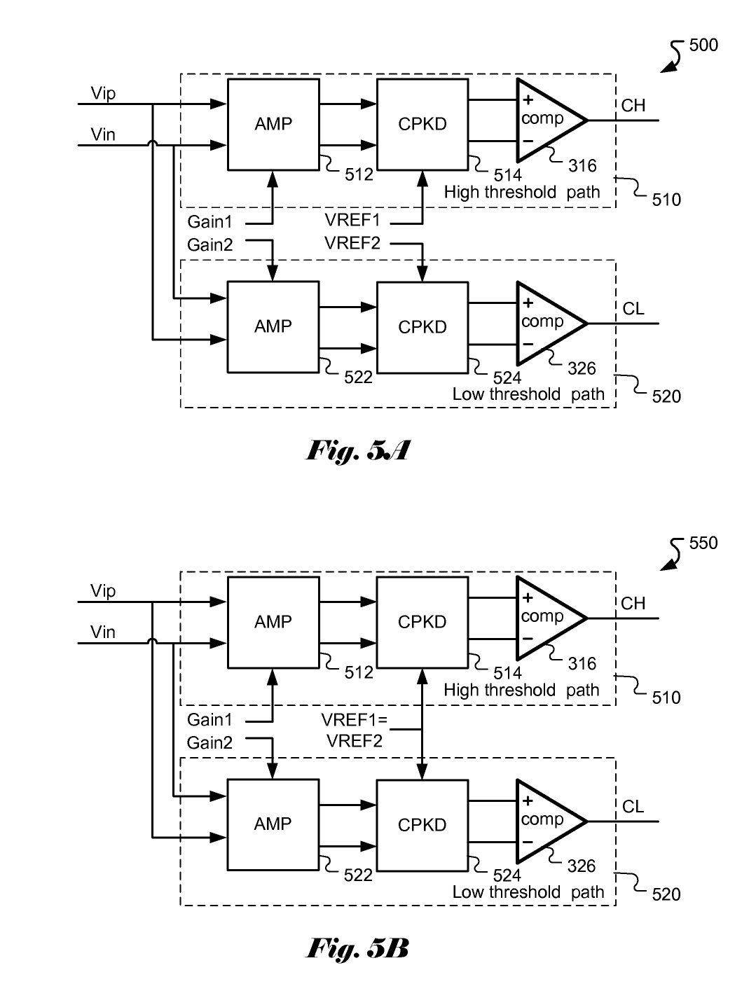

The input-output transfer function for Meyer's peak detector is shown in FIG. 4 where the horizontal axis corresponds to the input amplitude and the vertical axis corresponds to the detected output amplitude. The transfer function is quite linear for larger input signals. However, when the input signal is small, the detected output loses its linearity. Consequently Meyer's peak detector introduces detection error which is dependent on the amplitude of the input signal. Other high frequency peak detector, such as diode based detector exhibits even worse characteristic, especially when the input amplitude is small. Operation amplifier based peak detector may also be used for the peak detector circuit in the block 314 and 324 to achieve accurate hysteresis. However, the operational amplifier based peak detector will consume high power in order to achieve the desired performance, which is not suitable for power-restrictive portable applications. When the detection error of peak detector is taken into account, the hysteresis H can be expressed as:

H=20·log[(Vref_{—}H−ERROR_{—}H)/(VREF_{—}L−ERROR_{—}L)], (1)

where ERROR_H and ERROR_L are the detection error of the peak detectors associated with block 314 and 324 respectively. Since ERROR_H and ERROR_L are highly amplitude dependent, as indicated by the transfer characteristic of FIG. 4 and also very sensitive to temperature and process variations, the hysteresis of the peak detector as shown in equation (1) becomes highly temperature and process dependent.

To overcome these issues, new peak detection with accurate hysteresis is disclosed. FIG. 5A illustrates an exemplary block diagram of the peak detection 500 embodying the feature of accurate hysteresis. As noted in FIG. 4, the input-output transfer characteristic exhibits noticeable nonlinearity for small input. Therefore, by using an amplifier for small input signal may shift the operating point to a region that is substantially linear. Consequently, a pair of amplifiers is used to amplify input signals. The peak detection 500 comprises two parallel paths: a high threshold path 510 and a low threshold path 520. The high threshold path 510 comprises a pre-amplifier 512, a peak detector CPKD 514, and a comparator 316. The gain of the pre-amplifier 512 can be set according to control signal Gain1. The reference voltage VREF1 is supplied to the peak detector CPKD 514. The low threshold path 520 comprises a pre-amplifier 522, a peak detector CPKD 524, and a comparator 326. The gain of the pre-amplifier 522 can be set according to control signal Gain2. The reference voltage VREF2 is supplied to the peak detector CPKD 524. Since the input signal is scaled by respective gain factors Gain1 and Gain2, the selection of voltage references VREF1 and VREF2 have to take into consideration of the gain factors. The peak amplitudes of the amplified signals are detected by respective peak detectors 514 and 524. The peak detector outputs are then applied to respective comparators 316 and 326 to derive respective logic output signals CH and CL. If proper gain factors Gain1 and Gain2 are applied, the amplified input signals should be in the linear region of the input-output transfer characteristic of FIG. 4. Accordingly, the detection error is reduced and the hysteresis becomes more accurate. The gain factors Gain1 and gain2 of the amplifiers and reference voltages VREF1 and VREF2 can be supplied from a set of register bits, which are not shown in FIGS. 5A and 5B, to control the hysteresis.

To further improve the hysteresis accuracy, the gain factors Gain1 and Gain2 can be properly selected so that the amplified input signals for the high threshold path and the low threshold path will have the same respective thresholds. For example, in FIG. 3, if the VREF_L is half of VREF_H, the gain factor Gain2, twice as large as the gain factor Gain1, will cause the VREF2 the same as VREF1 in FIG. 5A. Consequently, the same reference voltage can be applied to the peak detectors, i.e., VREF1=VREF2 as shown in FIG. 5B. Furthermore, peak detectors for blocks 514 and 524 can be implemented using the same size. Therefore, the detection error of the system 550 in FIG. 5B having identical reference voltage and identical circuit implementation of blocks 514 and 524 is very small and can be ignored. The hysteresis of this peak detection is determined by the gain ratio of the two pre-amplifiers 512 and 522, and can be very accurate if the pre-amplifiers are properly designed.

To properly operate the system of FIG. 5A, the pre-amplifier gain factor Gain1 for the high threshold path 510 should be low while the pre-amplifier gain factor Gain2 for the low threshold path 520 should be high. For the high threshold path 510, if the input amplitude is higher than the high threshold VH=VREF1/Gain1, the comparator 316 will generate a logic ‘1’. For the low threshold path 520, if the input amplitude is lower than the low threshold VL=VREF2/Gain2, the comparator 326 will generate a logic ‘1’. Therefore, the hysteresis of corresponding to the system of FIG. 5A is given by:

H=20·log(VH/VL)=20·log[(VREF1·Gain2)/(VREF2·Gain1)]. (2)

The hysteresis can be controlled by adjusting the reference voltages VREF1 and VREF2 and the gain factors Gain1 and Gain2 of the pre-amplifiers.

For the special case, VREF1=VREF2, the hysteresis H becomes:

H=20·log(VH/VL)=20·log(Gain2/Gain1), (3)

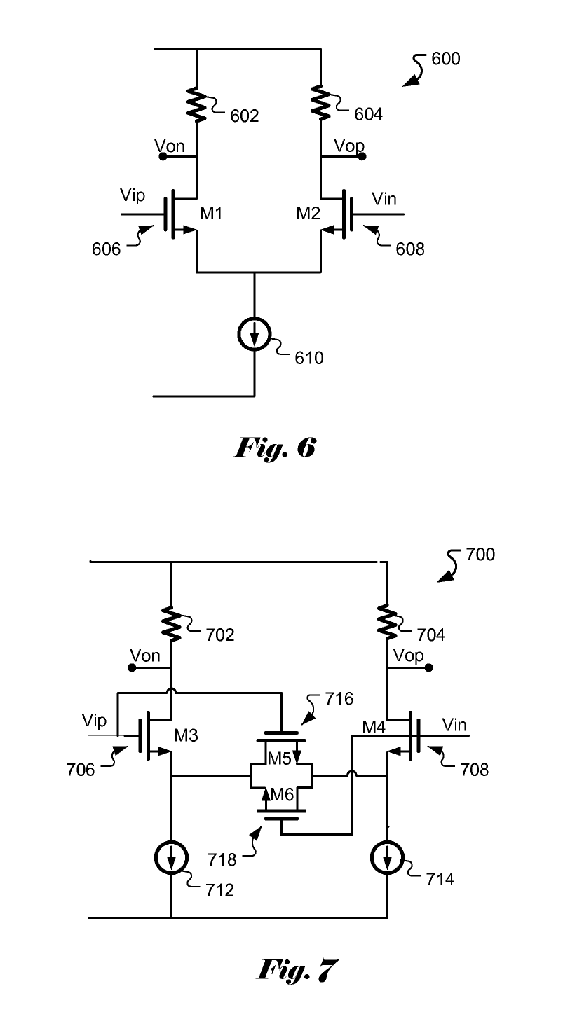

which is determined by the gain ratio of the two pre-amplifiers. FIG. 6 illustrates the schematic of an exemplary high gain pre-amplifier 600 for the low threshold path 520. Since the amplitude of the input signal is rather small, a differential pair is used as the input stage for better performance. The load resistors 602 and 604 of the amplifier 600 are implemented using poly resistor in order to achieve high frequency performance. The current source 610 is used to provide the needed current for the circuit. Transistors M1 606 and M2 608 are used as input device for the input differential signal pair Vip and Vin. The gain of this amplifier is determined according to AH=gm·RL, where gm is the trans-conductance of the input devices M1 and M2, and RL is the resistance of the load resistors.

For the high threshold path 510, it is used to detect large input amplitude and the path requires a low gain for the pre-amplifier. Therefore, source degeneration should be added in the low gain pre-amplifier in order to support large linear input range. FIG. 7 illustrates the schematic of an exemplary low-gain amplifier 700, where a resistor pair 702 and 704 is used as loads of the amplifier to achieve high frequency performance. Input transistors M3 706, M4 708 and source degeneration transistors M5 716 and M6 718 are used as input devices, where transistor M3 706 and transistor M4 708 have the same size and transistor M5 716 and transistor M6 718 have the same size. The pre-amplifier 700 contains two current sources 712 and 714. The gain of this amplifier is determined according to AL=Gm·RL, where Gm is the equivalent trans-conductance of the input devices. Accordingly, the gain ratio of the amplifiers in FIG. 6 and FIG. 7 can be expressed as

AH/AL=gm/Gm. (4)

In the high gain pre-amplifier, the trans-conductance of M1 606 equals to

gm=2·IB/VDSAT, (5)

where IB and VDSAT are the bias current and overdrive voltage of M1 606 respectively. For the low gain amplifier, the equivalent trans-conductance of the input stage equals to

Gm=2·IB/[(1+0.25·B3/B5)·VDSAT] (6)

where B3 and B5 are the aspect ratios of transistor M3 706 and transistor M5 716 respectively. If the bias current and overdrive voltage of transistor M3 706 in the low gain amplifier and transistor M1 606 in the high gain amplifier are the same, the gain ratio can be derived by substituting (5) and (6) into (4),

AH/AL=1+0.25·B3/B5. (7)

Therefore the gain ratio becomes dependant only on the aspect ratio of transistor M3 706 in the low gain amplifier and transistor M1 606 in the high gain amplifier, which can be controlled accurately. Consequently, accurate hysteresis for peak detection is achieved.

The high gain pre-amplifier in FIG. 6 and the low gain pre-amplifier in FIG. 7 are illustrated as examples to implement the required pre-amplifiers required by the systems of FIGS. 5A and 5B. The present invention is not limited to the particular implementation of the pre-amplifiers. These skilled in the art may practice the present invention by replacing the pre-amplifiers in FIGS. 6 and 7 with other pre-amplifiers.

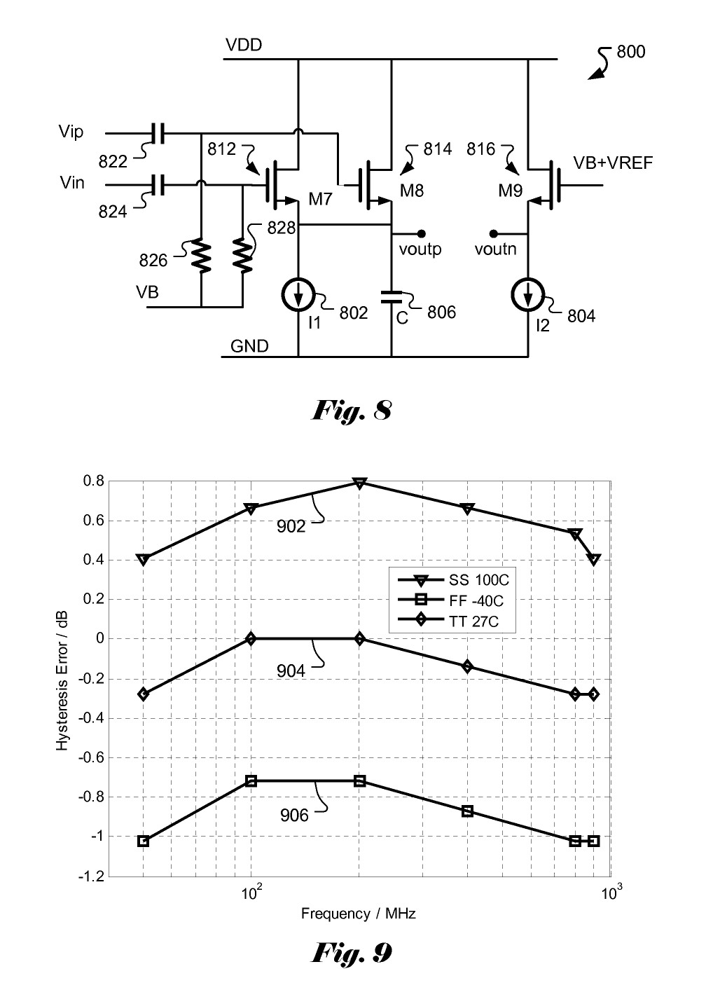

FIG. 8 illustrates the schematic of an exemplary high frequency peak detector for the CPKD blocks 514 and 524 of FIGS. 5A and 5B. The peak detector circuit 800 is similar to the bipolar peak detector disclosed by Meyer in the publication entitled “Low-Power Monolithic RF Peak Detector Analysis”, IEEE Journal of Solid-State Circuit, Vol. 30, pp. 65-67, January 1995. However, the peak detector circuit 800 is for a differential input signal which can balance the load of the LNA. In the peak detector circuit 800, the discharging currents I1 802 and I2 804 are preferred to be very small, and the capacitor C 806 is preferred to be large enough so that M7 812 and M8 814 operate in a sub-threshold region. The capacitors 822 and 824 are used to block the DC voltage on the input pair Vip and Vin. The bias voltage VB is coupled to the gates of transistor M7 812 and transistor M8 814 through respective resistors 826 and 828. On the other hand, the reference voltage VREF along with the bias voltage VB, i.e., VB+VREF, is applied to the gate of transistor M9 816. The output voltage of the peak detector of FIG. 8 equals to

$${V}_{O} = A - VREF - {nU}_{T} \cdot ln [ \frac{{( W / L )}_{3}}{2 \cdot {( W / L )}_{1}} \cdot \sqrt{\frac{2 π A}{{nU}_{T}}} ] , \qquad ( 8 )$$

where A is the amplitude of the input signal, n is the slope factor of transistor M7 812, transistor M8 814 and transistor M9 816, and U_{T}=kT/q. The detection error can be eliminated by properly choosing the aspect ratio of transistor M7 812 and transistor M9 816 and current ratio of I1 802 and I2 804. Although hysteresis of the peak detector is accurate, the low and high threshold values will vary with process and temperature. To overcome this issue, the reference voltage is made programmable according to process and temperature where the reference voltage may be supplied from programmable registers.

FIG. 9 illustrates the simulated hysteresis error corresponding to the peak detection of FIG. 5B using the circuit 600 of FIG. 6 for the high gain pre-amplifier 522, the circuit 700 of FIG. 7 for the low gain pre-amplifier 512, and the peak detector 800 of FIG. 8 for the CPKD blocks 514 and 524. In the simulated circuit, the low threshold is 42 mV, the high threshold is 126 mV, and the carrier frequency range is from 50 MHz to 900 MHz. Hysteresis error at different process corners and temperatures is simulated, where the result for SS corner at 100° C. is represented by the curve 902, the result for FF corner at −40° C. is represented by the curve 904, and the result for TT corner at 270° C. is represented by the curve 906. As shown in FIG. 9, the maximum error is about 1 dB.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A threshold detection module for detecting a high threshold and a low threshold of an input signal using a peak detection circuit having non-linear characteristic at low signal level, comprising:
a high threshold path unit coupled to the input signal to provide a high threshold output according to a high threshold reference signal; and
a low threshold path unit coupled to the input signal to provide a low threshold output according to a low threshold reference signal;
wherein the high threshold path unit comprises:
a first amplifier coupled to the input signal to provide a first amplified signal according to a first gain factor; and
a first peak detection circuit coupled to the first amplified signal to provide the high threshold output according to the high threshold reference signal modified by the first gain factor; and
wherein the low threshold path unit comprises:
a second amplifier coupled to the input signal to provide a second amplified signal according to a second gain factor, wherein the second gain factor is larger than the first gain factor; and
a second peak detection circuit coupled to the second amplified signal to provide the low threshold output according to the low threshold reference signal modified by the first gain factor.

2. The threshold detection module of claim 1, wherein a same reference value is applied to the first peak detection circuit and the second peak detection circuit by selecting the first gain factor and the second gain factor according to (the first gain factor*the high threshold reference signal)=(the second gain factor*the low threshold reference signal).

3. The threshold detection module of claim 2, wherein the first peak detection circuit and the second peak detection circuit are implemented by a same circuit design with a same size.

4. The threshold detection module of claim 1, wherein the first amplifier comprises an input device having a first input transistor pair and a second input transistor pair coupled to the input signal, wherein the second input transistor pair has drain-source cross-connected and the drain-source cross-connected is coupled to sources of the first input transistor pair, wherein the first gain factor is associated with equivalent trans-conductance of the input device.

5. The threshold detection module of claim 4, wherein the equivalent trans-conductance of the input device is associated with a ratio of a first aspect ratio of the first input transistor pair and a second aspect ratio of the second input transistor pair.

6. The threshold detection module of claim 1, wherein the second amplifier comprises an input transistor pair coupled to the input signal, wherein the second gain factor is associated with trans-conductance of the input transistor pair.

7. The threshold detection module of claim 1, wherein a programmable register is used to supply the first gain factor and the second gain factor.

8. The threshold detection module of claim 1, wherein a programmable register is used to supply the high threshold reference signal and the low threshold reference signal.

9. A method for detecting a high threshold and a low threshold of an input signal using a peak detection circuit having non-linear characteristic at low signal level, comprising:
providing a first gain factor for amplifying the input signal to obtain a first amplified signal;
providing a second gain factor for amplifying the input signal to obtain a second amplified signal, wherein the second gain factor is larger than the first gain factor;
providing a first reference signal to a first peak detection circuit to obtain a high threshold output, wherein the first reference signal is associated with high threshold reference signal modified by the first gain factor; and
providing a second reference signal to a second peak detection circuit to obtain a low threshold output, wherein the second reference signal is associated with low threshold reference signal modified by the second gain factor.

10. The method of claim 9, further comprising a step of matching the first reference signal with the second reference signal by selecting the first gain factor and the second gain factor according to (the first gain factor*the high threshold reference signal)=(the second gain factor*the low threshold reference signal).
